(19) United States
(12) Patent Application Publication
(10) Pub. No.: US 2009/0254817 A1
(43) Pub. Date: Oct. 8, 2009

(54) Enhanced spell checking utilizing a social network

(75) Inventors: Marc Dreyfus, Brooklyn, NY (US); Derek S. Lam, Minneapolis, MN (US); Asima Silva, Holden, MA (US); Robert C. Weir, Westford, MA (US)

Correspondence Address: Cuenot, Forsythe & Kim, LLC, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 12/061,685

(22) Filed: Apr. 3, 2008

(51) Int. Cl. G06F 17/24

(52) U.S. Cl. 715/257

(57) ABSTRACT

A computer-implemented method of enhancing spell check. The method can include receiving from each of a plurality of clients at least one custom term and at least one class identifier that is associated with the custom term. The custom terms and the associated class identifiers can be processed to provide an electronic dictionary that includes a plurality of shared terms. Each of the shared terms can be associated with at least one of the class identifiers to which the shared term corresponds. Each of the custom terms can correspond to at least one of the shared terms. At least one of the shared terms can be output to at least one of the plurality of clients.

### FIELD OF THE INVENTION

The embodiments of the present invention relate to electronic processing of text and, more particularly, to spell checking.

### BACKGROUND OF THE INVENTION

The use of spell checking is common in applications such as word processors, text editors, presentation applications, and e-mail clients. Functions that implement spell checking typically compare individual words in a document, pane or file to entries in one or more locally stored dictionaries to determine whether the words are properly spelled. In general, words that do not have a corresponding match in the locally stored dictionary are indicated as being misspelled, usually with some form of text underlining or highlighting.

A standard dictionary is typically provided for each language that may be used when generating text on a particular computer. In addition, domain specific dictionaries sometimes are provided for use in various professions, such as the medical and legal professions. Personal dictionaries also may be provided to encode words used by a user that are not necessarily contained in any other locally stored dictionaries. Such words may be proper names, names of products, acronyms, jargon, or the like. Typically, an application will allow one or more of the locally stored dictionaries to be concurrently active. For example, an attorney may have a standard English dictionary, a legal dictionary, and a personal dictionary concurrently accessible for use in spell checking.

### BRIEF SUMMARY OF THE INVENTION

The embodiments disclosed herein relate to a computer-implemented method of enhancing spell check. One embodiment of the present invention can include receiving from each of a plurality of clients at least one custom term and at least one class identifier that is associated with the custom term. The custom terms and the associated class identifiers can be processed to provide an electronic dictionary comprising a plurality of shared terms, each of the shared terms being associated with at least one of the class identifiers to which the shared term corresponds, and each of the custom terms corresponding to at least one of the shared terms. Based on at least one of the class identifiers, at least one of the shared terms can be selectively output to at least one of the plurality of clients.

Another embodiment of the present invention can include communicating to a server at least a first custom term and at least a first class identifier that is associated with the custom term. At least one shared term associated with the first class identifier can be received from the server, the shared term generated by processing the first custom term and at least a second custom term that likely is an equivalent of the first custom term. The shared term can be accessed when spell check is performed on at least one subject term.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating a system for enhancing spell check in accordance with one embodiment of the present invention.

FIG. 2 is a view of a user interface in accordance with one embodiment of the present invention.

FIG. 3 is another view of a user interface in accordance with one embodiment of the present invention.

FIG. 4 is another view of a user interface in accordance with one embodiment of the present invention.

FIG. 5 is a flowchart illustrating a method of enhancing spell check in accordance with another embodiment of the present invention.

FIG. 6 is another flowchart illustrating a method of enhancing spell check in accordance with another embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit,” “module,” or “system.”

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, a magneto-optical disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

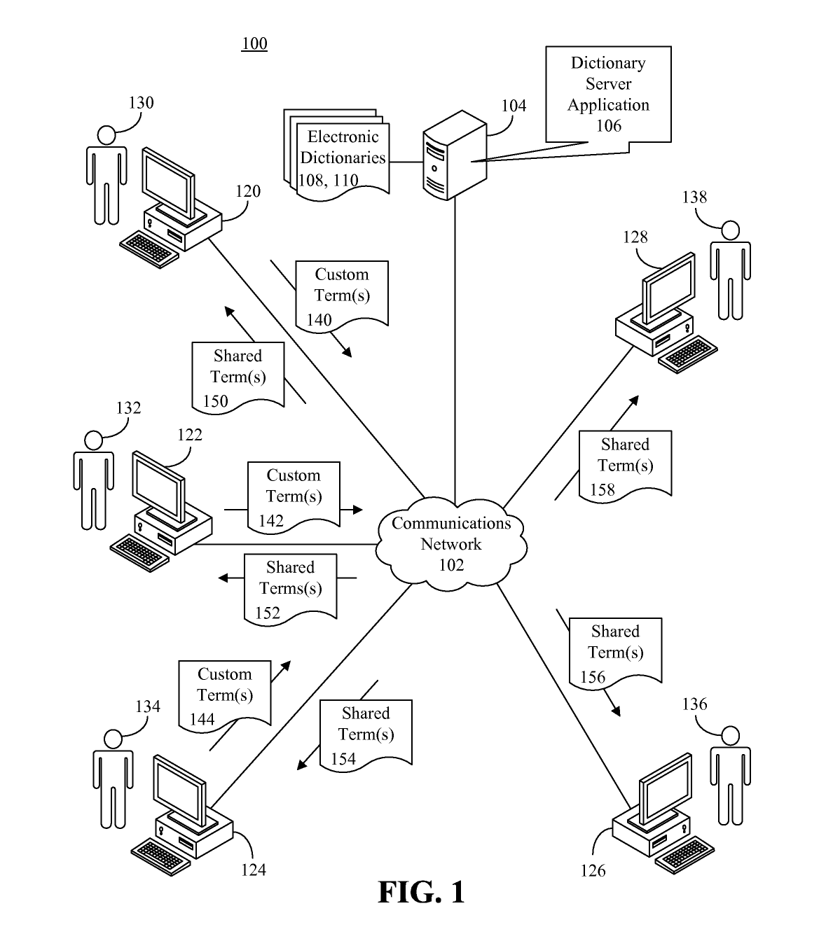

FIG. 1 is a block diagram illustrating a system 100 for enhancing spell check in accordance with one embodiment of the present invention. The system 100 can include a communications network 102, which can be implemented as, or include, without limitation, a WAN, a LAN, the Public Switched Telephone Network (PSTN), the Web, the Internet, and one or more intranets. The communications network 102 further can be implemented as or include one or more wireless networks, whether short or long range. For example, in terms of short range wireless networks, the communications network 102 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long range wireless networks, the communications network 102 can include a mobile, cellular, and or satellite-based wireless network and support voice, video, text, and/or any combination thereof, e.g., GSM, TDMA, CDMA, and/or WCDMA network.

The system 100 can include a server 104, which can comprise a data processing system on which a dictionary server application 106 is instantiated. The dictionary server application 106 can generate and/or update one or more electronic dictionaries 108, 110 to include shared terms that are custom in nature, and make such electronic dictionaries 108, 110 available for use by one or more clients 120, 122, 124, 126, 128 within the system 100 for use in spell checking, as will be described herein. The electronic dictionaries 108, 110 can be stored in one or more data tables, data files, text files, or in any other suitable format, and can be stored on the server 104 or otherwise made accessible to the dictionary server application 106.

Each of the clients 120-128 may comprise a data processing system. For example, the clients can be computers, mobile stations (e.g. mobile computers, personal digital assistants, mobile telephones, or the like), set-top boxes, internet appliances, or any other data processing systems on which spell check may be implemented. The clients 120-128 can be communicatively linked to the server 104, either directly or via the communications network 102.

In one embodiment, users 130, 132, 134, 136, 138 of the respective clients 120-128 can be members of a social network. As used herein, a “social network” is a social structure comprising nodes, which may be individuals or organizations, that are associated to one another by one or more specific interdependencies. Examples of such interdependencies can include, but are not limited to, place of employment, occupation, department association, division association, geographic location, hobby, education status, educational institution, college major, religion, and so on.

In operation, users 130-138 of the clients 120-128 can identify custom terms which may be added as shared terms to one or more electronic dictionaries. For example, the users 130-134 can identify custom terms 140, 142, 144, respectively. As used herein, “custom term” means a term that a user 130-138 selects to add to an electronic dictionary 108, 110. The term “electronic dictionary” means a list of terms that may be used by a data processing system as a standard against which to check the spelling and/or structure of subject terms (e.g. terms entered into a word processor, an e-mail client, a text editor, a presentation application, a graphics application, an Internet browser, or the like).

A custom term 140-144 may have a structure that is unique in comparison to other equivalent terms. Such structure can be the manner in which the term is spelled, the manner in which lower case and upper case letters are used, the manner in which hyphens or other non-letter characters are used, the manner in which blank spacing is used, or the like. For example, a particular word may already be contained in the electronic dictionary 108, but have a structure in which letters are typically presented in lower case (e.g. “electronic”). A user 130-138 may want to add a term comprising the same word, but in which certain letters are always presented in uppercase (e.g. “elecTRONic”). A user 130-138 also may want to add a term comprising an alternative spelling of the same word (e.g. “electronik”), or a term comprising characters that are not letters (e.g. “Electron-IC”). Further, it should be noted that a custom term is not limited to a single word, but may comprise one or more words, one or more acronyms, one or more non-letter characters (e.g. numerals or symbols), one or more additional letters, or the like.

Class identifiers can be assigned to one or more of the custom terms 140-144. The class identifiers can indicate classes with which the respective terms 140-144 are to be associated. For example, a class identifier for the custom term 140 can indicate a particular project or group with which the custom term 140 is associated. A custom term 140-144 can be associated with any desired number of classes. Accordingly, any desired number of class identifiers can be assigned to each term 140-144. For instance, the custom term 142 can be associated with a first class identifier indicating a particular product, and a second class identifier indicating a particular corporate department. A restriction indicator also can be assigned to one or more custom terms 140-144 to indicate terms that have restricted use. For instance, a restriction indicator can be assigned to custom term 144 that is associated with a confidential project.

Custom terms 140-144 that are identified can be communicated to the server 104, for instance via the communications network 102, which may pass the terms to the dictionary server application 106. In one embodiment, the custom terms 140-144 can be contained in custom dictionaries generated and/or updated on the clients 120-128, and then communicated to the server 104 within the custom dictionaries. In another arrangement, the custom terms 140-144 can be communicated to the server 104 in another suitable file format, or in messages without the use of files. Further, the custom terms 140-144 can be communicated individually or in groups of custom terms 140-144. The custom terms 140-144 can be communicated from the clients 120-128 to the server 104 in response to a request from the server 104, in response to one or more events detected by the clients 120-128, in response to a user input into the server or the respective clients 120-128, or at a scheduled interval. For example, each client 120-128 can be configured to communicate custom terms 140-144 as such terms are identified by the users 130-138 as being custom terms or as such terms are added to a custom dictionary.

The custom terms 140-144 that are communicated to the server 104 and/or processed by the dictionary server application 106 can be limited to those terms that are indicated as being non-private (e.g. public) terms. For example, when identifying a custom term 140, the user 130 can indicate whether the custom term 140 is private or non-private. If the custom term 140 is private, the term need not be communicated to the server 104. If the custom term 140 is private and is communicated to the server 104, the dictionary server application 106 can ignore the custom term 140 when generating or updating the electronic dictionaries 108, 110.

Further, the server 104 can receive the custom terms 140-144 exclusively from clients 120-128 associated with a social network. Indeed, custom terms 140-144 received from clients 120-128 having different social network affiliations can be treated independently, as will be described. The social network affiliations for each client 120-128 can be defined by the users 130-138 (e.g. via settings and/or login information), and can change when different users are active on the clients 120-128.

As noted, the dictionary server application 106 can process the custom terms 140-144 to provide (e.g. generate or update) one or more of the electronic dictionaries 108, 110. For example, the dictionary server application 106 can add each of the custom terms 140-144 to an electronic dictionary 108 to generate a shared term, and then remove duplicates. Alternatively, when adding custom terms 140-144 to the electronic dictionary 108, the dictionary server application 106 can skip terms 140-144 that are duplicates of shared terms already contained in the electronic dictionary 108. As used herein, “shared term” means a custom term, as defined herein, which is electronically shared among a plurality of clients or users. For example, a shared term can be shared among two or more of the clients 120-128 or users 130-138 via the communications network 102.

A plurality of custom terms 140-144 may be received which are likely to be equivalent, but have different structures. For example, the custom terms 140, 142 may have the same structure, for example “EcoRaceReady” while the custom term 144 is a different structure, for example “Ecoracereadie”. In this situation, the dictionary server application 106 can implement suitable rules for selecting which of the terms 140-144 to add to one or more of the dictionaries 108, 110 to generate a corresponding shared term. For example, the dictionary server application 106 can identify each of the terms 140-144 as shared term candidates, and select from the shared term candidates the custom term 140-144 that has the structure which is most commonly used among the users 130-138. In one embodiment, the dictionary server application 106 can maintain a listing of the shared term candidates and track the frequency by which each of the shared term candidates are used. If the structure that is most frequently used changes, the dictionary server application 106 can update the shared term to correspond to the most frequently used structure. Identification of shared term candidates and selection of a shared term from such candidates can be implemented using suitable rules, functions, algorithms and/or parameters.

Any class identifiers assigned to the custom terms 140-144 can be associated with the corresponding shared terms in the electronic dictionaries 108, 110. Similarly, any assigned restrictions also can be associated with the corresponding shared terms. If a particular custom term 140-144 is assigned multiple class identifiers, the dictionary server application 106 can associate the most commonly used identifier with the corresponding shared term, or can associate a plurality of the class identifiers with the corresponding shared term. In another embodiment, one or more of the electronic dictionaries 108, 110 can be class specific dictionaries which are assigned to particular class identifiers. The class specific dictionaries can include as shared terms exclusively the custom terms 140-144 that are assigned corresponding class identifiers. In that regard, a class specific dictionary can be generated by processing an electronic dictionary in a manner which filters the shared terms based on assigned class identifiers.

In an embodiment in which the clients 120-128 are affiliated with different social networks, the custom terms 140-144 can be processed according to such affiliations. For example, dictionary server application 106 can provide (e.g. generate or update) one or more electronic dictionaries for each social network, and custom terms 140-144 generated by a particular client 120-128 can be exclusively processed to generate shared terms for the dictionary or dictionaries assigned to the social network with which the client 120-128 is affiliated. The social network affiliations can be identified by the dictionary server application 106 in any suitable manner. For example, indications of social network affiliations can be received by the server 104 when the custom terms 140 are communicated to the server 104, when the users 130-138 enter user information into the respective clients 120-128, or at any other suitable time. In another embodiment, indicators that indicate social network affiliations can be stored on the server 104, or otherwise made accessible by the server. For instance, a data table, data file, or text file can be maintained that associates the users 130-138 with respective social networks. The social network affiliations can be identified when the users 130-138 log onto the communications network 102 via the clients 120-128.

The dictionary server application 106 can communicate shared terms 150, 152, 154, 156, 158 of one or more of the electronic dictionaries 108, 110 to a plurality of the clients 120-128. The clients 120-128 to which the shared terms 150-158 are communicated can be selected based on social network affiliations, shared term/dictionary subscription status, or in any other suitable manner. Such clients 120-128 can be, but need not be, the same clients 120-128 from which the custom terms were received. The shared terms 150-158 can be communicated to the clients 120-128 in response to requests generated by the clients 120-128 or users 130-138, a request generated by the dictionary server application 106, a request generated by a user of the server 104 or the dictionary server application 106, at a scheduled interval, or in response to one or more events detected by the server 104.

Further, the selection of the shared terms 150-158 to communicate to each of the clients 120-128 can be implemented in any suitable manner. By way of example, if the clients 120-128 or users 130-138 subscribe to particular electronic dictionaries 108, 110, the dictionary server application 106 can communicate to the clients 120-128 updates comprising shared terms 150-158 that have been added to the electronic dictionaries 108, 110 since the last of such updates. In another embodiment, the dictionary server application 106 can communicate the electronic dictionaries 108, 110 to the clients 120-128. As noted, an electronic dictionary 108, 110 can contain all shared terms, or can be a class specific dictionary comprising only those terms associated with a particular class or with a plurality of particular classes. In yet another embodiment, the dictionary server application 106 communicates the shared terms 150-158 independent of the dictionaries. For example, the dictionary server application 106 can select all of the shared terms 150-158 from one or more of the dictionaries 108, 110 and communicate such shared terms 150-158 to the clients 120-128. In another embodiment, the dictionary server application 106 can select from the dictionaries 108, 110 only shared terms 150-158 that are associated with class identifiers to which the clients 120-128 or users 130-138 subscribe, and communicate to the clients 120-128 only those shared terms 150-158.

The dictionary server application 106 also can communicate to the clients 120-128 the class identifiers and/or restrictions corresponding to the respective shared terms 150-158. Such class identifiers/restrictions can be communicated in the same manner in which the shared terms are communicated, or in any other suitable manner.

The clients 120-128 can make the shared terms 150-158 available for access by applications for use in spell checking. For example, the clients 120-128 can update one or more spell checking dictionaries, replace one or more spell check dictionaries with one or more electronic dictionaries 108, 110 received, or add the received electronic dictionaries 108, 110 as additional spell check dictionaries. Such functionality can be implemented manually, or with a suitable driver or application. Accordingly, during spell check, subject terms being checked for spelling can be compared to the shared terms 150-158 to determine whether the subject terms are spelled appropriately.

Optionally, certain ones of the shared terms 150-158 can be conditionally activated (or deactivated) for use in spell checking based upon their assigned class identifiers. For instance, if the user 138 has selected a particular class of shared terms for use in spell checking, only shared terms assigned the corresponding class identifier will be used for spell checking purposes. Accordingly, when spell check is performed, custom terms that are not contained in standard spell check dictionaries will not be identified as being misspelled.

Further, if during a spell check a subject term is identified that corresponds to a shared term 150-158 that is designated as being restricted (e.g. associated with a restriction) an alert can be presented to the user 130-138. Such alert can be implemented with a suitable driver or spell check computer program that interfaces with the application in which the spell check is being performed. The alert can comprise a message, an indicator applied to the restricted term (e.g. strikethrough, redaction, etc.), or any other suitable event. In this manner a user 130-138 can be cautioned against using terms that are potentially confidential or otherwise sensitive in nature. Optionally, the user can be provided an option to remove any indicators applied to the restricted term.

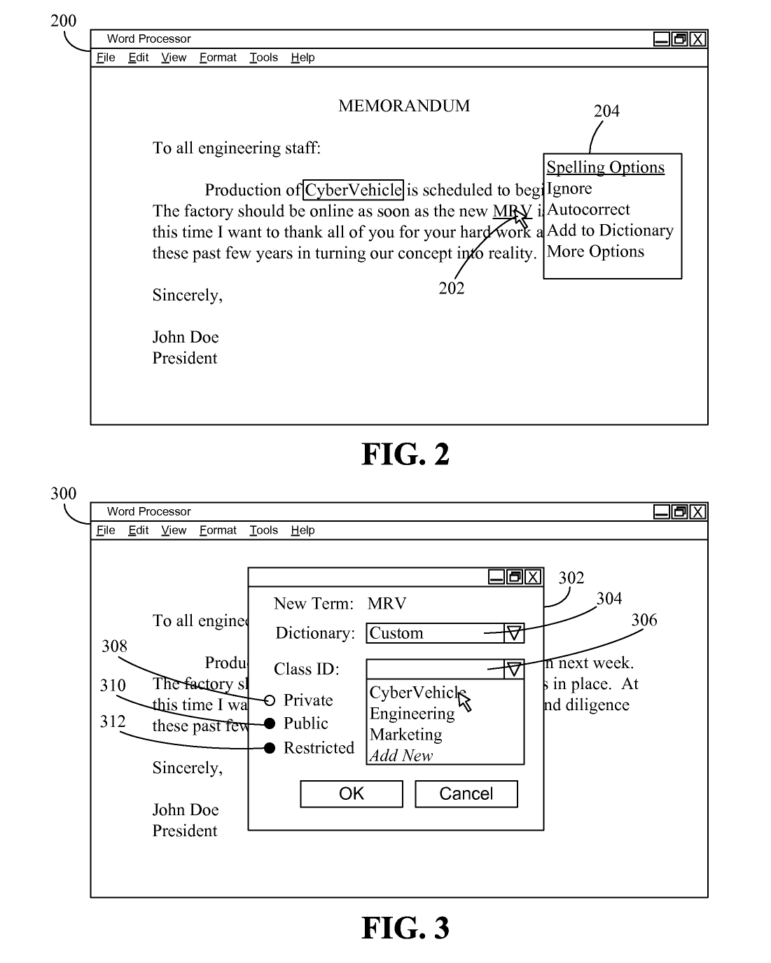

FIG. 2 is a view 200 of a user interface in accordance with one embodiment of the present invention. The user interface can be presented on a client. In operation, a spell checker can identify terms that are not recognized, and therefore potentially misspelled. Such terms can be those terms not currently contained in a local dictionary. In addition, terms that are restricted can be identified. In the present example, the term “MRV” can be identified as not being recognized and potentially misspelled, and the term “CyberVehicle” can be identified as being restricted. Such identifications can be presented in any suitable manner and the invention is not limited in this regard.

A user can select the term “MRV”, for instance by navigating a cursor 202 over the term, and activate an option menu 204. As will be appreciated by one skilled in the art, the menu 204 can be presented in any suitable manner and is not limited to the example presented herein. The user then can select an appropriate action for handling the term “MRV”, for example the user can choose to add the term “MRV” to a dictionary. An example of a suitable dictionary is a “custom” dictionary contained on the client, although the user also may have the option of adding the term to another suitable dictionary. In response to the selection, further options can be presented to the user.

For example, as depicted in the view 300 of FIG. 3, another menu 302 can be presented to the user to provide various options that may be available. For instance, a field 304 can be presented to prompt the user to select a dictionary in which to add the term “MRV”, and a field 306 can be presented to prompt the user to select a class identifier for the term. Other options also may be presented. For instance, fields 308, 310, 312 can be presented to identify whether the term is private or public, and whether the term is restricted. The menu 302 and fields 304-312 can be presented in any suitable manner and the invention is not limited in this regard. Further, any other desired windows and/or fields may be provided for classifying and/or handling the term, or for implementing any other desired functions or processes.

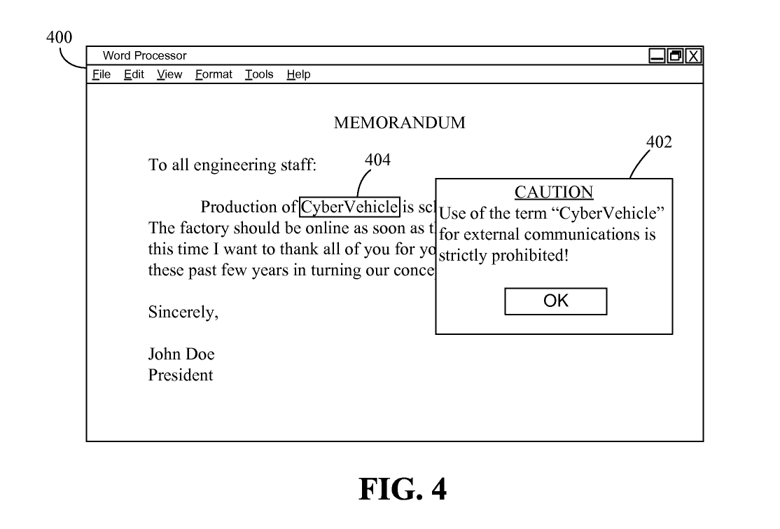

FIG. 4 is another view 400 of the user interface in accordance with one embodiment of the present invention. In response to a restricted term “CyberVehicle” being identified, a message 402 can be presented to alert the user that such term is a restricted term. One or more indicators 404 also can be applied to the term to identify its restricted status. As the skilled artisan will appreciate, the message 402 and indicator(s) 404 can be presented in any desired manner.

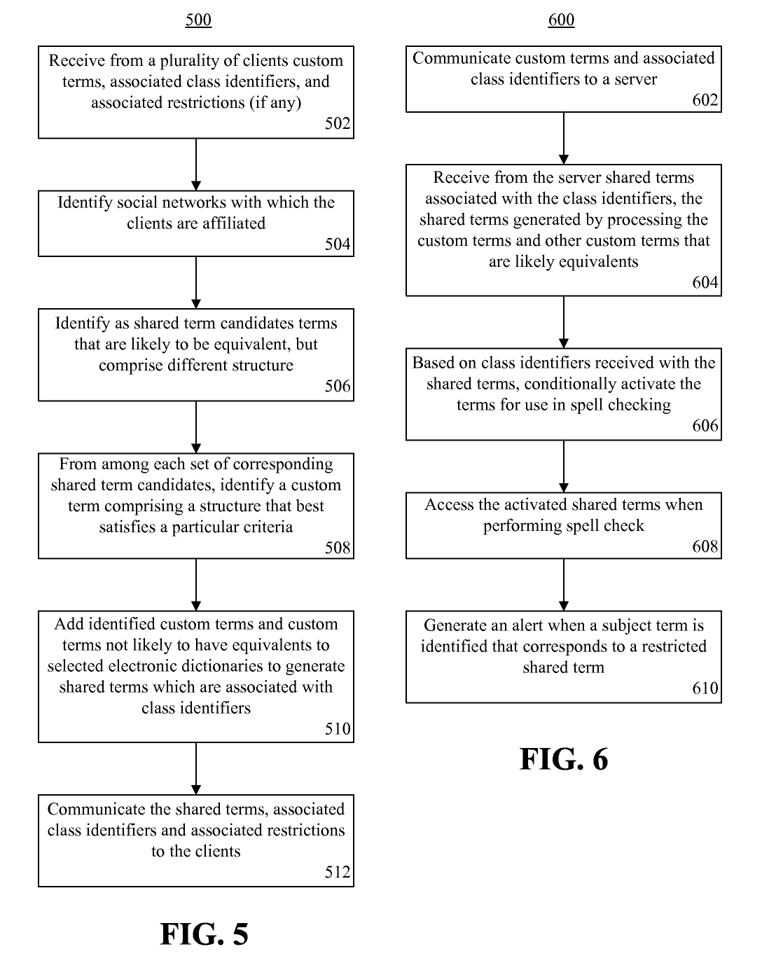

FIG. 5 is a flowchart illustrating a method 500 of enhancing spell check in accordance with another embodiment of the present invention. At step 502, custom terms and associated class identifiers can be received from one or more clients. Optionally, restrictions associated with the custom terms, if any, also can be received. At step 504, the social networks with which the clients are affiliated can be identified. At step 506, custom terms that are likely to be equivalent but comprise different structure can be associated with one another and identified as shared term candidates. At step 508, from each set of corresponding shared term candidates, a custom term that comprises a structure that best satisfies a particular criteria, for example the structure that is used most often, can be identified.

At step 510, the custom terms identified from among the shared term candidates, as well as custom terms that were not identified as likely being equivalent to other custom terms, can be added to selected electronic dictionaries to generate shared terms, each of which may be associated with one or more of the class identifiers to which it corresponds. For example, each shared term can be associated with one or more class identifiers that are associated with the custom term(s) from which the shared term was generated. As noted, the electronic dictionaries can be selected based on social network affiliations and/or the class identifiers. At step 512, based on the class identifiers, the shared terms can be communicated to a plurality of clients, for example those with selected social network affiliations. The class identifiers and restrictions, if any, associated with the shared terms also can be communicated to the clients.

FIG. 6 is a flowchart illustrating a method 600 of enhancing spell check in accordance with another embodiment of the present invention. At step 602, custom terms and associated class identifiers can be communicated to a server, for instance a server on which a dictionary server application is instantiated. At step 604, shared terms and their associated class identifiers can be received from the server. The shared terms can be those generated by the dictionary server application by processing the custom terms that were communicated, as well as processing other custom terms received by the server. At step 606, the shared terms can be conditionally activated for use in spell checking. For instance, the shared terms can be assigned to custom dictionaries based on their class identifiers, and the shared terms can be activated for use during spell check when their respective custom dictionaries are selected. In another embodiment, all of the shared terms received can be added to a single custom dictionary along with their corresponding class identifiers. Terms to be used during spell check then can be activated when their corresponding class identifiers are selected. At step 608, the activated shared terms can be accessed when performing spell check. At step 610, an alert can be generated when a subject term is identified that corresponds to a restricted shared term.

As used herein, “output” or “outputting” can include, but is not limited to, storing data in memory, e.g., writing to a file, writing to a user display or other output device, e.g., playing audible notifications, sending or transmitting to another system, exporting, or the like.

The flowchart(s) and block diagram(s) in the figures illustrate the architecture, functionality, and operation of possible implementations of systems, methods and computer program products according to various embodiments of the present invention. In this regard, each block in the flowchart(s) or block diagram(s) may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram(s) and/or flowchart illustration(s), and combinations of blocks in the block diagram(s) and/or flowchart illustration(s), can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A computer-implemented method of enhancing spell check, the method comprising:
receiving from each of a plurality of clients at least one custom term and at least one class identifier that is associated with the custom term;
processing the custom terms and the associated class identifiers to provide an electronic dictionary comprising a plurality of shared terms, each of the shared terms being associated with at least one of the class identifiers to which the shared term corresponds, and each of the custom terms corresponding to at least one of the shared terms; and
based on at least one of the class identifiers, selectively outputting to at least one of the plurality of clients at least one of the shared terms.

2. The computer-implemented method of claim 1, wherein receiving the custom terms comprises:
receiving the custom terms exclusively from clients affiliated with at least one social network.

3. The computer-implemented method of claim 2, wherein processing the custom terms comprises:
identifying the social network with which the clients are affiliated; and
processing the custom terms to generate shared terms for an electronic dictionary associated with the identified social network.

4. The computer-implemented method of claim 1, further comprising:
processing the electronic dictionary to generate a class specific dictionary exclusively comprising shared terms that are associated with at least one of the class identifiers.

5. The computer-implemented method of claim 1, wherein processing the custom terms comprises:
for each of the custom terms:
determining whether the custom term is a duplicate of a shared term that is already contained in the electronic dictionary; and
adding the custom term to the electronic dictionary to generate a shared term when the custom term is not a duplicate of a shared term already contained in the electronic dictionary.

6. The computer-implemented method of claim 1, wherein processing the custom terms comprises:
from among the plurality of custom terms, identifying as shared term candidates custom terms that are likely to be equivalent, but comprise different structure;
from among the shared term candidates, identifying a custom term comprising a structure that best satisfies a particular criteria; and
exclusively adding the identified custom term to the electronic dictionary to generate one of the shared terms.

7. The computer-implemented method of claim 6, wherein processing the electronic dictionary to generate the class specific dictionary further comprises:
processing the electronic dictionary to exclude from the class specific dictionary shared terms that are not associated with at least a minimum number of instances of the at least one specified class identifier.

8. The computer-implemented method of claim 1, wherein receiving from each of a plurality of clients at least one custom term comprises:
receiving from each of the plurality of clients a custom dictionary comprising at least one of the custom terms.

9. The computer-implemented method of claim 1, wherein processing the custom terms comprises:
adding each custom term to the electronic dictionary to generate a shared term; and
removing duplicate shared terms from the electronic dictionary.

10. A computer-implemented method of enhancing spell check, the method comprising:
communicating to a server at least a first custom term and at least one class identifier that is associated with the custom term;
receiving from the server at least one shared term associated with the class identifier, the shared term generated by processing the first custom term and at least a second custom term that likely is an equivalent of the first custom term; and
accessing the shared term when spell check is performed on at least one subject term.

11. The computer-implemented method of claim 10, further comprising:
conditionally activating the shared term for use in spell checking based on the class identifier.

12. The computer-implemented method of claim 10, further comprising:
receiving from the server at least one restriction associated with the shared term; and
generating an alert when a subject term corresponding to the shared term is identified during the spell check.

13. A computer program product comprising:
a computer-usable medium comprising computer-usable program code that enhances spell check, the computer-usable medium comprising:
computer-usable program code that receives from each of a plurality of clients at least one custom term and at least one class identifier that is associated with the custom term;
computer-usable program code that processes the custom terms and the associated class identifiers to provide an electronic dictionary comprising a plurality of shared terms, each of the shared terms being associated with at least one of the class identifiers to which the shared term corresponds, and each of the custom terms corresponding to at least one of the shared terms; and
computer-usable program code that, based on at least one of the class identifiers, selectively outputs to at least one of the plurality of clients at least one of the shared terms.

14. The computer program product of claim 13, wherein the computer-usable program code that receives the custom terms comprises:
computer-usable program code that receives the custom terms exclusively from clients affiliated with at least one social network.

15. The computer program product of claim 14, wherein the computer-usable program code that processes the custom terms comprises:
computer-usable program code that identifies the social network with which the clients are affiliated; and
computer-usable program code that processes the custom terms to generate shared terms for an electronic dictionary associated with the identified social network.

16. The computer program product of claim 13, wherein the computer-usable medium further comprises:
computer-usable program code that processes the electronic dictionary to generate a class specific dictionary exclusively comprising shared terms that are associated with at least one of the class identifiers.

17. The computer program product of claim 13, wherein the computer-usable program code that processes the custom terms comprises:
computer-usable program code that for each of the custom terms:
determines whether the custom term is a duplicate of a shared term that is already contained in the electronic dictionary; and
adds the custom term to the electronic dictionary to generate a shared term when the custom term is not a duplicate of a shared term already contained in the electronic dictionary.

18. The computer program product of claim 13, wherein the computer-usable program code that processes the custom terms comprises:
computer-usable program code that, from among the plurality of custom terms, identifies as shared term candidates custom terms that are likely to be equivalent, but comprise different structure;
computer-usable program code that, from among the shared term candidates, identifies a custom term comprising a structure that best satisfies a particular criteria; and
computer-usable program code that exclusively adds the identified custom term to the electronic dictionary to generate one of the shared terms.

19. The computer program product of claim 18, wherein the computer-usable program code that processes the electronic dictionary to generate the class specific dictionary further comprises:
computer-usable program code that processes the electronic dictionary to exclude from the class specific dictionary shared terms that are not associated with at least a minimum number of instances of the at least one specified class identifier.

20. The computer program product of claim 13, wherein the computer-usable program code that receives from each of a plurality of clients at least one custom term comprises:
computer-usable program code that receives from each of the plurality of clients a custom dictionary comprising at least one of the custom terms.
